(19) United States
(12) Patent Application Publication
(10) Pub. No.: US 2013/0057846 A1
(43) Pub. Date: Mar. 7, 2013

(54) METHOD FOR CAPTURING AN OBJECT IN AN ENVIRONMENT OF A MOTOR VEHICLE

(71) Applicants: Mirko Mählisch, Gaimersheim (DE); Stefan Wender, Ingolstadt (DE); Matthias Rudolph, Ingolstadt (DE)

(72) Inventors: Mirko Mählisch, Gaimersheim (DE); Stefan Wender, Ingolstadt (DE); Matthias Rudolph, Ingolstadt (DE)

(73) Assignee: Audi AG, Ingolstadt (DE)

(21) Appl. No.: 13/605,516

(22) Filed: Sep. 6, 2012

(30) Foreign Application Priority Data
Sep. 7, 2011 (DE) 10 2011 112 715.5

(51) Int. Cl. G01C 3/08

(52) U.S. Cl. 356/4.07; 356/5.01

(57) ABSTRACT

In a method for capturing an object in an environment of a motor vehicle, the object is captured with a first capture device of the motor vehicle, and a second capture device which is different from the first capture device is activated when the object is captured by the first capture device. A distance between the motor vehicle and the object is determined with the second capture device.

### CROSS-REFERENCES TO RELATED APPLICATIONS

This application claims the priority of German Patent Application, Serial No. 10 2011 112 715.5, filed Sep. 7, 2011, pursuant to 35 U.S.C. 119(a)-(d), the content of which is incorporated herein by reference in its entirety as if fully set forth herein.

### BACKGROUND OF THE INVENTION

The present invention relates to a method for capturing an object in an environment of a motor vehicle. The present invention also relates to a motor vehicle.

The following discussion of related art is provided to assist the reader in understanding the advantages of the invention, and is not to be construed as an admission that this related art is prior art to this invention.

Modem motor vehicles include a number of driver assist systems, wherein an object is captured in the environment of the motor vehicle and an action is performed depending on the captured object or a corresponding message is outputted to the driver. Examples are distance warning systems, adaptive cruise control systems, systems for active pedestrian protection, brake assistants or parking aids.

The distance between a motor vehicle and an object can be measured with high accuracy by using capture devices which transmit a signal and determine the distance to the object based on the propagation time of the signal reflected by the object. These active capture devices have the advantage that the spacing or the distance between the motor vehicle and the object can be determined with high precision. However, these active capture devices disadvantageously tend to consume a large amount of energy during operation and are expensive. Passive capture devices which only capture the object typically require less energy; however, the distance between the motor vehicle and the object can only be approximately determined with these passive capture devices.

It is therefore an object of the present invention to determine the distance between a motor vehicle and an object with high precision, and also with high energy efficiency.

It would therefore be desirable and advantageous to obviate prior art shortcomings and to provide an improved method and device for determining the distance between a motor vehicle and an object with high energy efficiency as well as high precision.

### SUMMARY OF THE INVENTION

According to one aspect of the present invention, a method for capturing an object in an environment of a motor vehicle includes the steps of capturing the object with a first capture device of the motor vehicle, activating a second capture device which is different from the first capture device and which includes a transmitter unit and a receiver unit, when an object is captured with the first capture device, and determining a distance between the motor vehicle and the object with the second capture device by transmitting with the transmitter unit a signal and determining with the receiver unit a propagation time of the signal reflected by the object. The receiver unit is activated during operation of the motor vehicle and the transmitter unit is activated only when an object is captured with the first capture device.

Typically, a capture device capable of essentially determining the presence of an object in the environment of the motor vehicle is used as the first capture device. In this context, objects may be moving objects, such as motor vehicles on the road, motorcyclists, bicyclists or pedestrians. However, such object may also include an obstacle in the travel lane, a lane boundary or objects outside the travel lane. The first capture device should preferably be configured to use the least amount of energy for cost-efficient operation. This first capture device may be permanently activated during operation of the motor vehicle, so that the presence of an object in the environment of the motor vehicle can be reliably determined.

The second capture device is activated when a corresponding object is captured in the environment of the motor vehicle with the first capture device. The second capture device is advantageously configured for precisely determining a distance between the motor vehicle and the object. The second capture device which typically consumes more electric energy than the first capture device is then only switched on when an object is actually present in the environment of the motor vehicle. When the second capture device is switched on or activated, the first capture device may also be deactivated. The distance from the motor vehicle to an object can thus be precisely determined in a particularly efficient manner.

According to an advantageous feature of the present invention, the second capture device may include a transmitter unit and a receiver unit. To determine the distance between the motor vehicle and the object, the transmitter unit transmits a signal and the receiver unit determines a propagation time of the signal reflected by the object. With this measurement approach, the distance between the motor vehicle and an object can be determined with the second capture device with particularly high precision. The signals transmitted by the transmitter unit may include, for example, optical radiation, radar beams, (pulsed) laser radiation, acoustic waves or electromagnetic waves. In this way, the distance between the motor vehicle and the object can be reliably determined with high precision.

According to an advantageous feature of the present invention, the receiver unit may be activated during operation of the motor vehicle and the transmitter unit may be activated only when an object is captured with the first capture device. The transmitter unit of the second capture device is hence only activated when needed. Because the transmitter unit of the second capture device has typically a high energy consumption, electric energy consumption and hence costs can be significantly reduced in this manner.

According to another advantageous feature of the present invention, the transmitter unit may transmit the signal in form of light in the infrared wavelength range. The distance between the object and the motor vehicle can be determined with particularly high precision by using infrared illumination in the transmitter unit, because the second capture device is then insensitive to brightness variations of the daylight. The second capture device may also be constructed as a photo mixing detector (PMD camera), whereby the object in the environment of the motor vehicle may be illuminated by light pulses and the propagation time of the reflected signal (time of flight) may be measured. Likewise, the phase shift between the transmitted and the reflected signal may be measured. The PMD camera typically includes a corresponding semiconductor component constructed to capture or detect the reflected light beams. This semiconductor component can also be constructed to generate a corresponding intensity image depending on the distance of the object from the motor vehicle or from the semiconductor component. In this way, the distance between the motor vehicle and the object can be reliably determined with high precision.

According to another advantageous feature of the present invention, the receiver unit of the second capture device may be used as the capture device for capturing the object. Initially, it is sufficient to only detect an object in the environment of the motor vehicle. This does typically not require two-dimensional camera images with depth resolution. For example, a monocular picture from a camera or capture device is sufficient. The receiver unit of the second capture device may thus be used for this purpose. Accordingly, no additional components or capture devices are required for capturing an object in the environment of the motor vehicle. This approach saves installation space and reduces costs.

According to another advantageous feature of the present invention, the receiver unit of the second capture device and an optical sensor unit of the motor vehicle may be used for capturing the object. In addition to the first capture device, which may for example be the receiver unit of the second capture device, an additional optical sensor unit of the motor vehicle may be used. For example, a camera already installed in the motor vehicle may be used for this purpose. A two-dimensional image or a stereographic image can then be generated from the signals generated by the two cameras or optical sensor devices and used to more precisely determine the distance of the object in the environment of the motor vehicle and its size or position. In this way, the object in the environment of the motor vehicle can be reliably and still cost-effectively captured, because sensor devices already installed in the motor vehicle can be employed.

According to another advantageous feature of the present invention, at least one environmental sensor of the motor vehicle may be used as the first capture device for capturing the object. For example, environmental sensors already installed in the motor vehicle, which are for example part of a driver assist system of the motor vehicle, may be used for capturing the object. For example, a radar detector, a far infrared camera, a laser scanner and the like may be used. The object in the environment of the motor vehicle can thus be captured efficiently and cost-effectively.

According to another advantageous feature of the present invention, the transmitter unit may include a plurality of light emitting devices, wherein when the second capture device is activated, those light emitting devices are activated which during operation illuminate an area in the environment of the motor vehicle that is associated with the captured object in a predetermined manner. The transmitter unit of the second capture device typically includes a plurality of light emitting devices which may be arranged, for example, in form of a matrix. Advantageously, light emitting diodes (LEDs) are used as light emitting devices. It is not necessary to illuminate the entire field of view of the second capture device; instead, only those light emitting devices or light emitting diodes may be controlled which adequately illuminate the object. The transmitter unit and hence the second receiver unit can thus be operated with high energy efficiency and the distance between the motor vehicle and the object can be determined with particularly high precision. The data regarding the position and/or size of the object provided by the first capture device may be transmitted by a suitable control device to the second capture device, thereby allowing the second capture device to control the respective light emitting devices.

According to another aspect of the present invention, a motor vehicle is provided which includes a first capture device configured to capture an object in an environment of the motor vehicle, a second capture device constructed differently from the first capture device and including a transmitter unit transmitting a signal and a receiver unit determining a propagation time of the signal reflected by the object. The second capture device is configured to capture the object in the environment of the motor vehicle and to measure a distance between the motor vehicle and the object. In addition, the motor vehicle includes a control device configured to activate the second capture device when an object is captured with the first capture device. The control device activates the receiver unit during operation of the motor vehicle and activates the transmitter unit only when an object is captured by the first capture device.

### BRIEF DESCRIPTION OF THE DRAWING

Other features and advantages of the present invention will be more readily apparent upon reading the following description of currently preferred exemplified embodiments of the invention with reference to the accompanying drawing, in which the sole:

FIG. 1 shows a schematic diagram of a motor vehicle is according to the present invention.

### DETAILED DESCRIPTION OF PREFERRED EMBODIMENTS

These embodiment depicted in the figure is to be understood as illustrative of the invention and not as limiting in any way. It should also be understood that the figure is not necessarily to scale and that the embodiment is sometimes illustrated by graphic symbols, phantom lines, diagrammatic representations and fragmentary views. In certain instances, details which are not necessary for an understanding of the present invention or which render other details difficult to perceive may have been omitted.

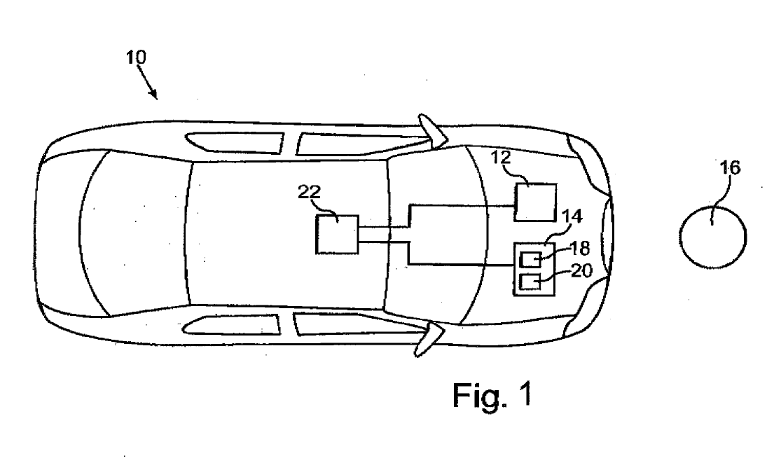

Turning now to the drawing, FIG. 1 shows a schematic diagram of a motor vehicle 10 in a top view. The motor vehicle 10 includes a first capture device 12 and a second capture device 14 that is different from the first capture device 12. The first capture device 12 is configured to capture the object 16 in the environment of the motor vehicle 10. The object 16 which is schematically illustrated in the figure may, for example, be another motor vehicle, a motorcycle, a bicyclist or a pedestrian. The object 16 can also be an obstacle on the road. In addition, the object 16 can be a corresponding lane boundary, such as a guardrail and the like. The object 16 may be movable or stationary.

The first capture device 12 may be constructed, for example, as an optical sensor, in particular a camera. The first capture device 12 may include for this purpose a suitable image processing program capable of distinguishing between corresponding objects 16 and/or patterns. In addition, the first capture device 12 may include an (unillustrated) storage element which stores previously defined patterns and/or objects 16. The first capture device 12 may be arranged, for example, in the radiator grille of the motor vehicle 10 or behind the windshield.

The second capture device 14 is configured to determine a distance between the motor vehicle 10 and the object 16. The second capture device 14 includes a transmitter unit 20 and a receiver unit 18. The transmitter unit 20 typically transmits a signal that is reflected by the object 16 and then received by the receiver unit 18. The distance between the motor vehicle and/or the receiver unit and the object 16 can then be determined from the propagation time of the signal. The signal transmitted by the transmitter unit 20 may include, for example, a radar signal, a (pulsed) laser signal, an acoustic signal, an optical signal and the like. Preferably, the transmitter unit 20 emits light in the infrared wavelength range. The receiver unit 18 of the second capture device 14 is configured to receive the signal reflected by the object 16. Preferably, the transmitter unit 20 emits light beams in the infrared wavelength range. The receiver unit 18 may include for this purpose corresponding semiconductor components capable of detecting the light reflected by the object 16. The second capture device 14 is preferably also disposed in the radiator grille of the motor vehicle 10 or behind the windshield.

During operation of the motor vehicle 10, the first capture device 12 may also be activated. When a corresponding object 16 is captured with the first capture device 12 in the environment of the motor vehicle, the second capture device 14 is additionally activated. For this purpose, the first capture device 12 and the second capture device 14 can be connected and/or coupled to a suitable control device 22. When the first capture device 12 captures a corresponding object 16, a signal can be transmitted to the control device 22. This signal can include information about the position and/or the size of the object 16. The control device 22 can transmit a corresponding signal which activates the second capture device 14. At the same time, the information about the position and/or the size of the object 16 can also be transmitted to the second capture device 14. The second capture device 14 is thus used only when a corresponding object 16 is detected by the first capture device 12. Because the second capture device 14 requires typically more electric energy than the first capture device 12, energy can be saved.

The first capture device 12 can be formed, for example, by environmental sensors already installed in the motor vehicle 10. The first capture device 12 can be constructed as a radar sensor, a far-infrared sensor or a camera. In one embodiment, the first capture device 12 can be formed by the receiver unit 18 of the second capture device 14. Likewise, the first capture device 12 can be formed, for example, by two different capture devices and/or environmental sensors.

The transmitter unit 20 of the second capture device 14 typically includes a plurality of light emitting devices, in particular light emitting diodes. When the second capture device 14 is activated, only those light emitting devices of the transmitter unit 20 may be activated which illuminate during operation an area in the environment of the motor vehicle 10 that is associated with the captured object 16 in a predetermined manner. In this way, the distance between the motor vehicle 10 and the object 16 can be determined with particularly high energy efficiency.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for capturing an object in an environment of a motor vehicle, comprising the steps of:
capturing the object with a first capture device of the motor vehicle,
activating, when an object is captured with the first capture device, a second capture device which is different from the first capture device and comprises a transmitter unit and a receiver unit, and
determining a distance between the motor vehicle and the object with the second capture device by transmitting with the transmitter unit a signal and determining with the receiver unit a propagation time of the signal reflected by the object, wherein the receiver unit is activated during operation of the motor vehicle and the transmitter unit is activated only when an object is captured with the first capture device.

2. The method of claim 1, wherein the signal transmitted with the transmitter unit comprises light in an infrared wavelength range.

3. The method of claim 1, wherein the receiver unit of the second capture device is used as the first capture device.

4. The method of claim 3, wherein the receiver unit of the second capture device and an optical sensor unit of the motor vehicle are used together as the first capture device.

5. The method of claim 1, wherein at least one environmental sensor of the motor vehicle is used as the first capture device.

6. The method of claim 1, wherein the transmitter unit comprises a plurality of light emitting devices, and wherein when the transmitter unit of the second capture device is activated, substantially those light emitting devices are activated which operate to illuminate an area in the environment of the motor vehicle associated with the captured object in a predetermined manner.

7. A motor vehicle comprising:
a first capture device configured to capture an object in an environment of the motor vehicle,
a second capture device constructed differently from the first capture device and comprising a transmitter unit transmitting a signal and a receiver unit determining a propagation time of the signal reflected by the object, said second capture device configured to capture the object in the environment of the motor vehicle and to measure a distance between the motor vehicle and the object,
a control device configured to activate the second capture device when an object is captured with the first capture device, wherein the control device activates the receiver unit during operation of the motor vehicle and activates the transmitter unit only when an object is captured by the first capture device.
